(19) United States
(12) Patent Application Publication
(10) Pub. No.: US 2017/0139530 A1
(43) Pub. Date: May 18, 2017

(54) TOUCH SCREEN SYSTEMS WITH REDUCED DIFFRACTION AND LATENCY VARIATION

(71) Applicant: GM GLOBAL TECHNOLOGY OPERATIONS LLC, Detroit, MI (US)

(72) Inventors: JAMES A. CARPENTER, Rochester Hills, MI (US); THOMAS A. SEDER, Fraser, MI (US)

(73) Assignee: GM GLOBAL TECHNOLOGY OPERATIONS LLC, Detroit, MI (US)

(21) Appl. No.: 15/350,727

(22) Filed: Nov. 14, 2016

Related U.S. Application Data
(60) Provisional application No. 62/255,958, filed on Nov. 16, 2015.

(51) Int. Cl. G06F 3/041; G06F 3/044

(52) U.S. Cl. CPC G06F 3/0416; G06F 3/044; G06F 2203/04103

(57) ABSTRACT

Touch screen systems are disclosed that include a substrate, a plurality of touch zones, and a plurality of trace lines. Some of the touch screen systems are defined wherein a first trace line has a length, defined from a touch zone to a terminal, that is greater than a length of a second trace line, and wherein the first trace line has a width that is greater than a width of the second trace line. Others of the touch screen system are defined wherein each trace line is defined as having an irregular trace pattern. Further, yet others of the touch screen systems include an insulative coating disposed over the substrate, the touch zones and the plurality of trace lines, wherein the insulative coating has a refractive index that substantially matches a refractive index of a conductive material used to form the trace lines and touch zones.

### CROSS-REFERENCE TO RELATED APPLICATIONS

This application claims the benefit of U.S. Provisional Application No. 62/255,958 filed Nov. 16, 2015.

### TECHNICAL FIELD

The technical field generally relates to touch screen systems. More particularly, the technical field relates to touch screen systems that exhibit reduced diffraction, as well as reduced latency variation.

### BACKGROUND

Touch screens have become an increasingly important input device. Touch screens use a variety of different touch detection mechanisms. One important type of touch screen is the capacitive touch screen. Capacitive touch screens are manufactured via a multi-step process. In a typical touch screen manufacturing process, a transparent conductive coating is formed into conductive traces or electrodes on one or more surfaces of the touch screen. The conductive traces typically form a grid that can sense the change in capacitance when a user's finger or a pointer touches the screen near an intersection of the grid. The scanning frequency of the touch screen is limited by a resistance/capacitive (RC) time constant that is characteristic of the capacitors. As the resistance of the trace becomes larger and larger, scanning times become proportionately longer and longer. Because of their location on the grid, some traces will necessarily be longer than others. Thus, conventional touch screens experience different touch latencies, depending on where on the grid the user touches, due to the different RC time constants of the different trace lengths.

Moreover, touch screens are typically transmissive of visible light so that an image can be viewed through the touch screen and have trace pattern repetition or regularity. Under some lighting conditions, undesirable effects such as visual artifacts such as reflection artifacts due to constructive an destructive interference resulting from the trace patterns regularity, the so-called “sun ball” diffraction pattern, may become visible. This can be undesirable from an aesthetic point of view or may interfere with information and images being shown by the display.

Accordingly, it is desirable to provide improved touch screen systems that exhibit reduced latency as the result of variable trace lengths. Furthermore, it is desirable to provide improved touch screen systems that exhibit reduced diffraction as a result of the pattern regularity of the transparent, conductive coating. Furthermore, other desirable features will become apparent from the following detailed description and the appended claims, taken in conjunction with the accompanying drawings and this background.

### SUMMARY

Various embodiments of touch screen systems are disclosed. In one exemplary embodiment, a touch screen system includes an electrically insulating, transparent substrate, a plurality of transmit and receive electrodes comprising a conductive material patterned on the substrate and defining a plurality of capacitive touch zones on the substrate between respective ones of the transmit and receive electrodes, and a plurality of trace lines, each trace line comprising the conductive material, each trace line patterned on the substrate extending from one of the transmit or receive electrodes to an edge terminal at an edge of the substrate. A first trace line of the plurality of trace lines has a length, defined from the respective touch zone to the respective edge terminal, that is greater than a length of a second trace line of the plurality of trace lines, and the first trace line has a width that is greater than a width of the second trace line.

In another exemplary embodiment, a touch screen system includes an electrically insulating, transparent substrate, a plurality of transmit and receive electrodes comprising a conductive material patterned on the substrate and defining a plurality of capacitive touch zones on the substrate between respective ones of the transmit and receive electrodes, and a plurality of trace lines, each trace line comprising the conductive material, each trace line patterned on the substrate extending from one of the transmit or receive electrodes to an edge terminal at an edge of the substrate. Each trace line of the plurality of trace lines is defined as having an irregular trace pattern.

In yet another exemplary embodiment, a touch screen system includes an electrically insulating, transparent substrate, a plurality of transmit and receive electrodes comprising a conductive material patterned on the substrate and defining a plurality of capacitive touch zones on the substrate between respective ones of the transmit and receive electrodes, a plurality of trace lines, each trace line comprising the conductive material, each trace line patterned on the substrate extending from one of the transmit or receive electrodes to an edge terminal at an edge of the substrate, and an insulative coating disposed over the substrate and over the touch zones and the plurality of trace lines. The insulative coating has a refractive index that substantially matches a refractive index of the conductive material.

### DESCRIPTION OF THE DRAWINGS

One or more embodiments will hereinafter be described in conjunction with the following drawing figures, wherein like numerals denote like elements, and wherein:

FIG. 1 is an illustration of a touch screen including conductive trace lines of varying widths, in accordance with some embodiments of the present disclosure;

FIG. 2 is an illustration of a touch screen including conductive trace lines of an irregular trace pattern, in accordance with various embodiments of the present disclosure;

FIG. 3 is an illustration of a touch screen including a dielectric coating having a refractive index that is substantially the same as the conductive trace lines, in accordance with various embodiments of the present disclosure;

FIG. 4 is a chart showing the relationship between stoichiometry and refractive index of an exemplary dielectric coating material;

FIG. 5 is an illustration of a touch screen including conductive trace lines of varying widths, of an irregular trace pattern, and including a dielectric coating having a refractive index that is substantially the same as the conductive trace lines;

FIG. 6 is an illustration of a vehicle information and entertainment system including a touch screen in accordance with any of the foregoing embodiments; and

FIG. 7 is an illustration of another device or apparatus implementing a touch screen in accordance with any of the foregoing embodiments.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the vehicle system described herein is merely one exemplary embodiment of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Embodiments of the present disclosure are generally directed to improved touch screen systems that exhibit reduced touch latency variation as well as reduced diffraction. In some of the disclosed embodiments, reduced touch latency is achieved by varying the thickness of the conductive traces as a function of the length of such traces. That is, longer traces are provided with greater thicknesses, and shorter traces are provided with lesser thicknesses. In this manner, the resistance/capacitive (RC) time constant variation based on trace length is reduced. In other embodiments, reduced diffraction is achieved by providing irregular trace patterns. Generally, conventional trace patterns are provided as straight line segments in a repeating pattern, with constant distances between trace lines. The term “irregular trace patterns” is used herein to refer to trace patterns that substantially exclude straight line segments and substantially exclude repeated patterns, as well as include varying distances between trace lines. In this manner, a diffraction pattern due to constructive and destructive interference by the reflected light is not apparent. In other embodiments, reduced diffraction is achieved by providing an insulative coating over the touch screen, wherein the coating has a refractive index that is substantially the same as the conductive trace material (such as indium tin oxide (ITO)). In this manner, a low reflection efficiency is achieved, thus resulting in a low diffraction efficiency.

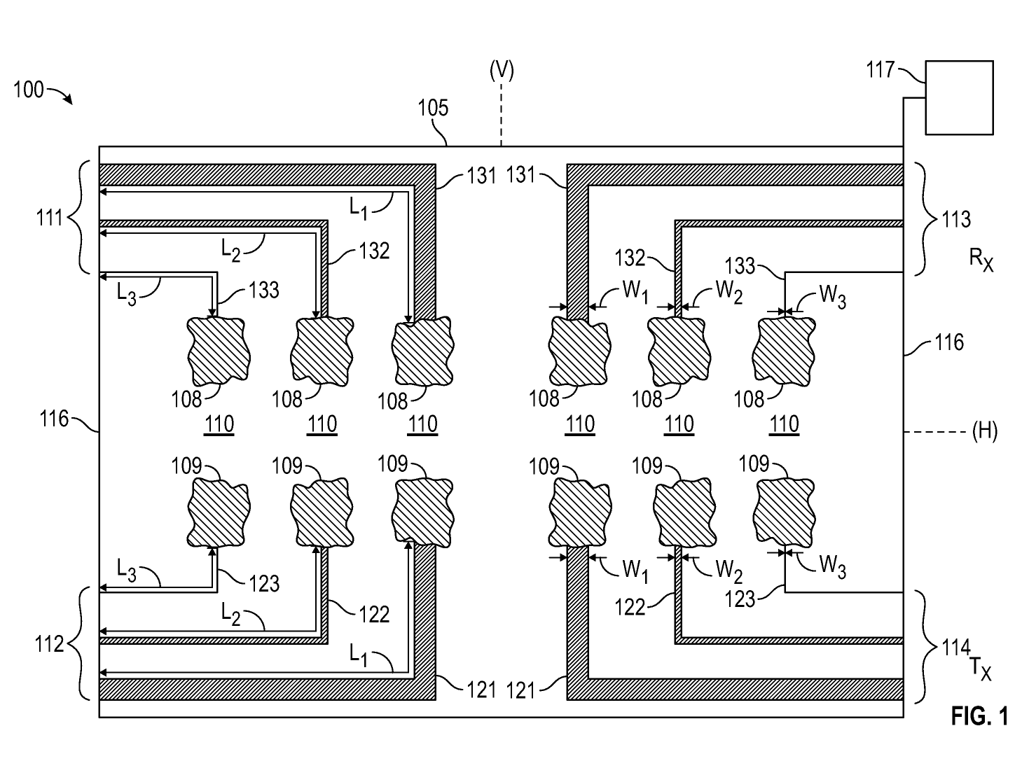

An exemplary touch screen 100 in accordance with some embodiments of the present disclosure is illustrated in FIG. 1. Touch screen 100 includes an electrically insulating, transparent substrate 105. The substrate 105 may be rigid or flexible. The substrate 105 may be glass, thin plastic, or a thick or rigid plastic sheet. A plastic substrate provides the advantage of being lightweight and difficult to break. Suitable substrates can include glass and various plastic materials such as polyethylene terapthalate (PET), various acrylics, polycarbonate, and any other substrate suitable for use in display applications whether now known or later developed. The size (area), shape, and thickness of the substrate may vary from embodiment to embodiment, as known in the art, and need not be rectangular or have any particular aspect ratio.

Provided on substrate 105, exemplary touch screen 100 includes a plurality of receive electrodes 108, a plurality of transmit electrodes 109, and a plurality of touch zones 110. Touch zones 110 are defined as areas on the touch screen that lie between a respective receive electrode 108 and transmit electrode 109 where a touch, by a user's finger or stylus, for example, may be sensed. When the electrodes are energized, a mutual capacitance appears between receive electrode 108 and transmit electrode 109 and a change in this mutual capacitance occurs when an object such as a finger is at the touch zone 110. FIG. 1 also illustrates a control module 117 (or other processing device) that receives signals from the conductive traces 131, 132, 133 associated with the touch zones 110 and based on the signals determines a change in capacitance at a particular touch zone 110, which thereby indicates that a particular touch zone 110 has been contacted by a touch of a user's finger, stylus, pointing instrument, etc. Touch zones 110 may generally be provided anywhere on the touch screen 110, and are not limited to the particular locations illustrated in the exemplary embodiment of FIG. 1. Further, it should be appreciated that more or fewer touch zones 110 may be provided, as compared to the illustrated embodiment. Further, the sizes of each touch zone 110 may vary, with respect to particular embodiment and between embodiments.

Each of the plurality of receive electrodes 108 and transmit electrodes 109 are physically and electrically connected to a conductive trace (or trace line) 121, 122, 123, 131, 132 or 133. Suitable transparent conductor materials for implementing the receive electrodes 108 and transmit electrodes 109 and the conductive traces 121, 122, 123, 131, 132 and 133 include transparent conductive oxides such as indium tin oxide (ITO), tin antimony oxide (TAO), zinc oxide (ZnO), other doped tin oxides, and the like (collectively referred to as transparent conductive oxides (TCOs)). Suitable transparent conductor materials also include conductive polymer materials such as polypyrrole, polyaniline, polyacetylene, polythiophene, polyphenylene vinylene, polyphenylene sulfide, poly p-phenylene, polyheterocycle vinylene. For example, an exemplary conductive polymer is a substituted polythiophene, poly (3,4-ethylenedioxythiophene), often referred to as PEDOT. The conductive traces may be applied and patterned using any conventional technique, such as high temperature or plasma sputtering, in the case of TCOs, or micro-printing in the case of polymers, to a thickness of about 50 to about 500 microns. The conductive traces 121, 122, 123 extend from a respective transmit electrodes 109 to an edge 116 of the substrate 105, for example at corners 112 and 114, to form corner terminals for applying a voltage to the conductive traces 121, 122, 123 (for example from a non-illustrated power source, as known in the art). Although the conductive traces 121, 122, 123 are generally illustrated as having a substantially right-angled configuration or “L-shape,” it should be appreciated that the conductive traces 121, 122, 123 may generally have any shape between a touch zone 110 and a corner terminal 112, 114 (Tₓ). Moreover, one or more of the conductive traces 121, 122, 123 may have a shape that is different from others of the conductive traces 121, 122, 123, and although they are depicted as symmetrical about horizontal axis (H) and vertical axis (V), other embodiments may feature asymmetric configurations (about one or both axes H, V). In an analogous fashion, the receive electrodes 108 are routed to edge 116 via conductive traces 131, 132 and 133 to corner terminals 111 and 113 (Rₓ).

Based on the configuration and positioning of the touch zones 110, it should be appreciated that conductive traces 121, 122, 123 and traces 131, 132, 133 will have differing lengths in order to reach a respective corner terminal 112, 114 and 111, 113, respectively. As such, traces 121 and 131 are illustrated with length L₁, traces 122 and 132 are illustrated with length L₂, shorter than L₁, and traces 123 and 133 are illustrated with length L₃, shorter than L₂. It should be appreciated that more or fewer different lengths of traces may be provided in a given embodiment. As initially noted above, this variation in trace length causes a variation in RC time constant, which can lead to differences in touch latency, depending on what location on screen 100 the touch occurs. Accordingly, FIG. 1 illustrates an embodiment of the present disclosure for reducing touch latency variation wherein longer length traces are provided with greater trace widths, and shorter length traces are provided with lesser trace widths. That is, traces 121 and 131 having length L₁ are provided with the greatest thickness or width, W₁, traces 122 and 132 having intermediate length L₂ are provided with an intermediate width, W₂, and traces 123 and 133 having the shortest length L₃ are provided with the narrowest width, W₃. There need not be any particular linear or other mathematical relationship between a given length L and a given width W of a trace. Rather, it is sufficient only that longer length traces have greater widths in order to reduce the variation in touch latency. The trace width range will depend on the number of touch areas. The impedance is matched for each trace and that the sheet resistance target for TCO is in the range of about 25 to about 100 ohms per square.

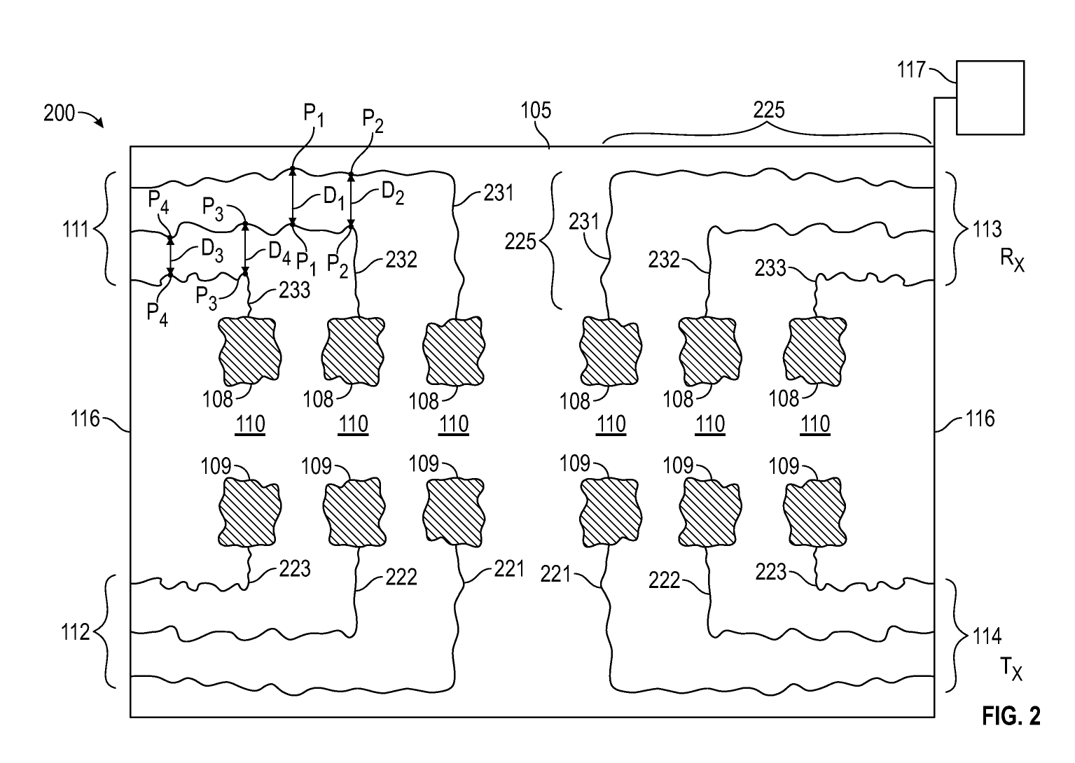

In one embodiment, with reference now to FIG. 2, a touch screen 200 is provided that includes a substrate 105, electrodes 108, 109, touch zones 110, and corner terminals 111-114 substantially as described above with regard to FIG. 1, and thus, the same reference numerals will be used to denote the same or substantially similar components. In contrast to the embodiment described above in FIG. 1, in which the conductive traces include two substantially linear trace segments to form the L-shape, touch screen 200 includes a plurality of conductive traces (or trace lines) 221, 222, 223, 231, 232 and 233 each of which is illustrated as having a non-linear, irregular trace pattern, and each of which extends between touch zone 110 and corner terminal 111-114. As discussed above, the term “irregular trace patterns” is used herein to refer to trace patterns that substantially exclude straight line segments and substantially exclude repeated patterns, as well as include varying distances between conductive traces. The irregular trace pattern may be referred to as wavy, undulating, kinked, rippled, and the like. In this manner, light reflective from the conductive traces does exhibit a regular pattern of constructive and destructive interference. Thus, the interference, or diffraction, pattern has reduced conspicuity.

For example, with particular attention to the conductive traces 231, 232, and 233 terminating at corner terminal 111 of touch screen 200, various distances may be defined between traces 231 and 232 (or 221 and 222). As shown, at one point P₁ between conductive traces 231 and 232, the separation distance may be D₁. However, at another point P₂ between conductive traces 231 and 232, the separation distance may be D₂, which is less than D₁. Also as shown, at one point P₃ between conductive traces 232 and 233 (or 222 and 223), the separation distance may be D₃. However, at another point P₄ between conductive traces 232 and 232, the separation distance may be D₄, which is greater than D₃.

In another example, with particular attention to the conductive traces 231, 232, and 233 terminating at corner terminal 113 of touch screen 200, in areas 225 of the trace 231, it is illustrated that such trace is substantially free of (i.e., substantially excludes) straight line segments and repeating patterns. Rather, trace 231 winds and curves irregularly along an entirety of its areas 225 from the touch zone 110 to the corner terminal 113. The term “substantially excludes,” as used herein, means that less than 50% of the overall length (i.e., the length of the trace line from the touch zone 110 to the corner terminal 113) of conductive traces lines (i.e. conductive traces 231, 232, 233) present on the touch screen 200 are free of straight line segments and repeating patterns, such as less than about 25%, or less than about 10%. While particular attention has been drawn to certain ones of the conductive traces 231, 232, 233 to illustrate the features of “irregular trace patters,” it should be appreciated from FIG. 2 that all of the conductive traces 231, 232, 233 include these features, and thus all of the conductive traces 231, 232, 233 of the touch screen 200 meet the stated definition of “substantially excludes” with regard to straight line segments and repeating patterns.

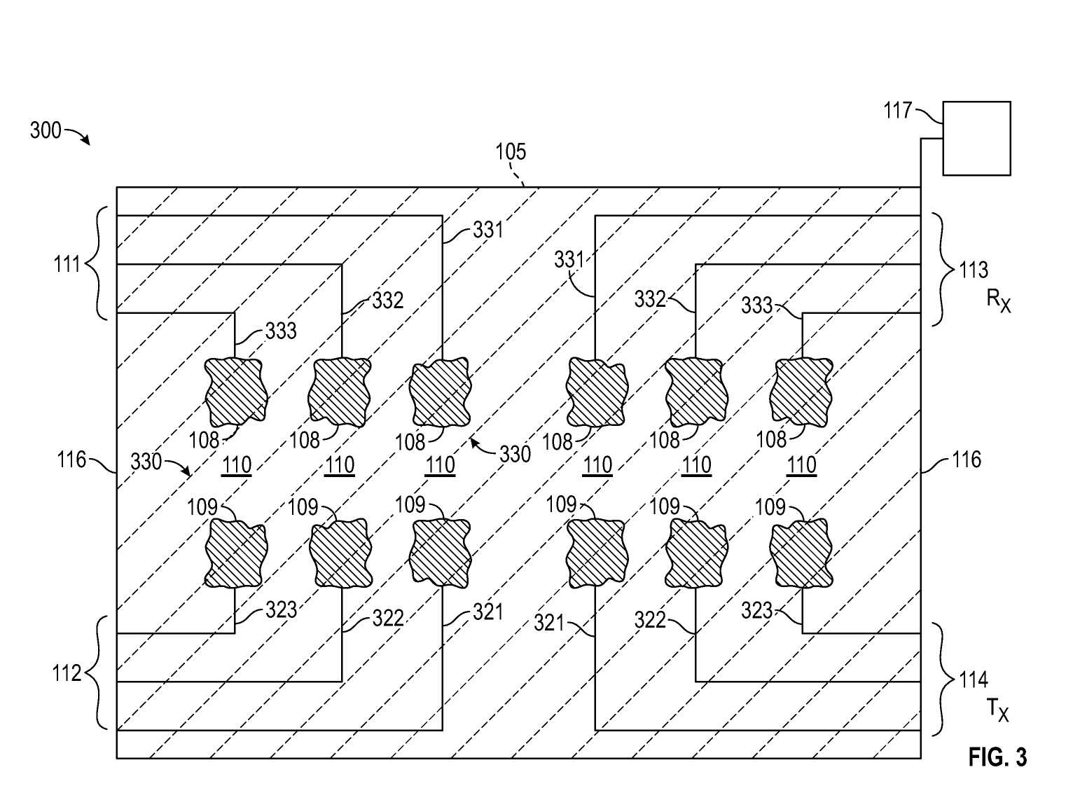

In yet another embodiment, with reference now to FIG. 3, a touch screen 300 is provided that includes a substrate 105, electrodes 108, 109, touch zones 110, and corner terminals 111-114 substantially as described above with regard to FIG. 1, and thus, the same reference numerals are used to denote the same or substantially similar components. Touch screen 300 also includes a plurality of conductive traces (or trace lines) 331, 332, 333, 321, 322, and 323, each of which extend between touch zone 110 and corner terminal 111-114. The touch zone and the conductive traces 331, 332, 333, 321, 322, 323 may generally be referred to as conductive elements, or elements that conduct electrical energy. Overlying the substrate 105 and the conductive elements 108, 109, 331, 332, 333, 321, 322, and 323 is an insulative or dielectric coating or material layer 330 (shown using diagonal, dashed lines). The material layer 330 may be provided at a thickness above the surface of substrate 105 of about 50 nm to about 200 nm, in some embodiments. The material layer 330 may cover all or a portion of the substrate 105. As used herein, the terms insulative and dielectric refer to materials that are each substantially non-conductive, i.e., prevent the conduction of electricity. The material layer 330 is also provided so as to have a refractive index that substantially matches the refractive index of the conductive material used to form conductive elements 108, 109, 331, 332, 333, 321, 322, 323. Thus, it should be appreciated that the particular insulative material chosen as the material layer 330 depends on the particular conductive material employed to form conductive elements 108, 109, 331, 332, 333, 321, 322, 323. In this manner, when the material layer 330 has a refractive index that is substantially the same as the conductive material to form conductive elements 108, 109, 331, 332, 333, 321, 322, 323, a low reflection efficiency is achieved, thus resulting in a low diffraction efficiency. Non-limiting examples of suitable dielectric materials for the material layer 300 include, but is not limited to, silicon oxynitride and titanium oxynitride. Each of these materials may be suitably provided over an ITO-based conductive trace pattern.

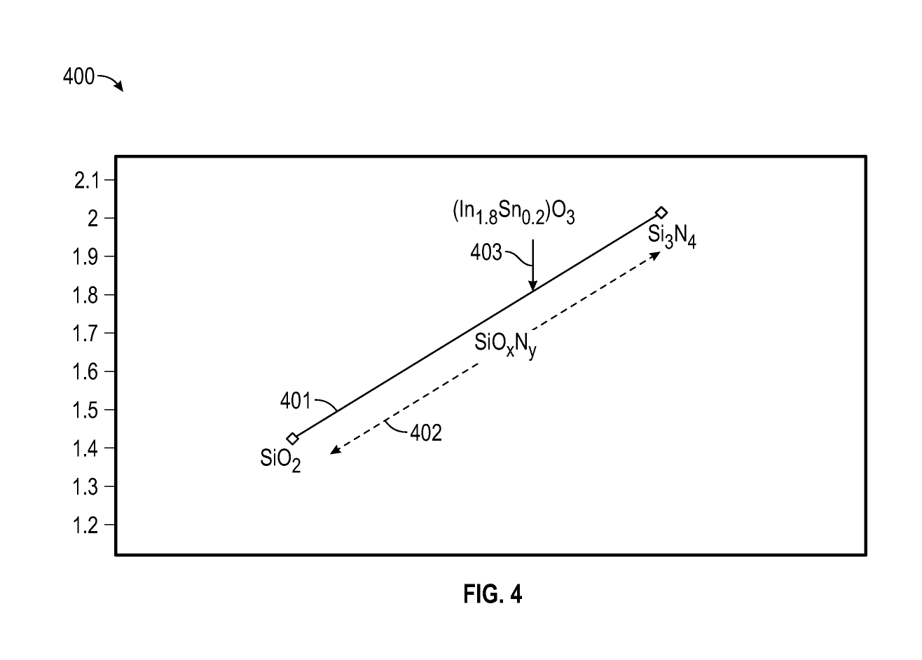

FIG. 4 is a chart 400 that illustrates the concept of “tuning” the material layer 330 on the basis of the particular conductive material used to form conductive elements 108, 109, 331, 332, 333, 321, 322, 323. In chart 400, the vertical axis provides refractive index value, and the horizontal axis represents changes in stoichiometry. Chart 400 includes a line 401 showing the refractive index of silicon-based insulative materials including various amounts of nitrogen and oxygen. As shown, pure silicon dioxide has the lowest refractive index (about 1.42), and pure silicon nitride has the highest refractive index (about 2.01). In between, various stoichiometric compositions of silicon oxynitride (SiOₓN_{y}) will have refractive indices between 1.42 and 2.01, as shown by dashed line 402. The aforementioned transparent conductive material indium tin oxide (ITO) is shown as having a refractive index of about 1.82 (arrow 403). For ITO as well, the refractive index changes based on stoichiometry (arrow 403 shows ITO with (In_{1.8}Sn_{0.2})O₃). Thus, in accordance with the present disclosure, to match the refractive index for applying the material layer 330, the particular material and stoichiometry of the conductive material is determined (the refractive indices for various conductive materials, such as ITO, are published and well-known in the art). Based on this determination, a suitable insulative material is selected (including its stoichiometry) to substantially match or to be substantially identical to the determined refractive index of the conductive material. As used herein, the term “substantially identical” refers to an index difference between the refractive index of the material layer and the refractive index of the conductive material used for the conductive elements 108, 109, 331, 332, 333, 321, 322, 323 of less than about 20%, such as less than about 10%, or less than about 5%.

As initially noted above, the conductive elements 108, 109, 331, 332, 333, 321, 322, 323, as well as the material layer 330, may be provided on the substrate 105 using high-temperature or plasma sputtering techniques. Using these techniques, in a vacuum chamber, metallic and intermetallic elements are provided on a plate, and then the plate is bombarded with varying amounts of gasses, which causes these elements to deposit on the substrate at the desired stoichiometry. For example, for sputter depositing an ITO material, a plate having a defined ratio of indium and tin is bombarded with a controlled amount of argon ion plasma, thereby causing ITO to sputter deposit onto the substrate 105 at a defined stoichiometry as determined by the amount of oxygen gas added present in the argon plasma. As another example, for sputter depositing silicon oxynitride, a plate having silicon is bombarded argon ions with controlled amounts of oxygen and nitrogen gasses added to the argon plasma, thereby causing SiOₓN_{y} to deposit onto the substrate 105 at a defined stoichiometry. Again, the stoichiometries should be defined such that the resulting materials have refractive indices that substantially match one another.

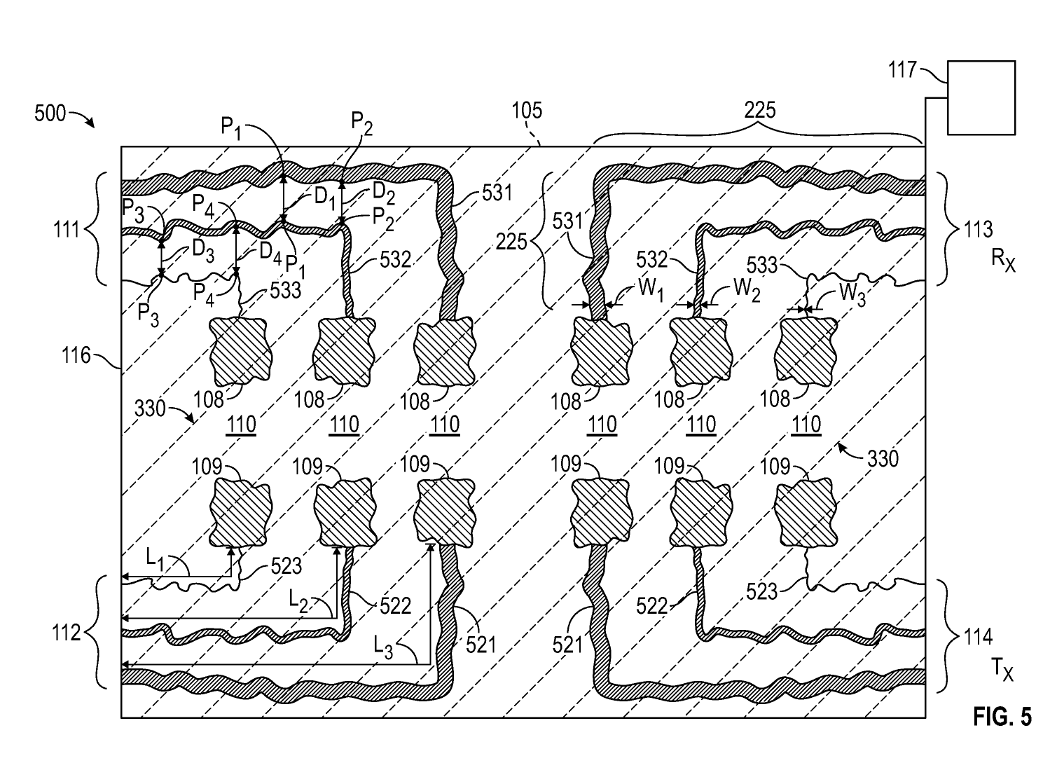

In one embodiment, with reference now to FIG. 5, a touch screen 500 is provided that includes a substrate 105, electrodes 108, 109, touch zones 110, and corner terminals 111-114 substantially as described above with regard to FIG. 1, and thus, the same reference numerals will be used to denote the same or substantially similar components. Touch screen 500 also includes conductive traces 531, 532, 533, 521, 522, and 523 that have a) varying widths (similar to traces 131, 132, 233, 121, 122, 123 of FIG. 1); b) irregular patterns (similar to traces 231, 232, 233, 221, 222, 223 of FIG. 2); and c) that are covered with the insulative dielectric material layer 330 that has a refractive index that substantially matches the refractive index of the conductive traces 531, 532, 533, 521, 522, 523 (similar as shown in FIG. 3). Of course, variations of this embodiment may include only concepts a) and b) (but not c)), a) and c) (but not b)), or b) and c) (but not a)), in various combinations and sub-combinations, as may be desired for a particular implementation. As such, the discussion of two or more of the concepts fully described above in FIG. 1, 2, or 3 should be understood as incorporated into the embodiments shown in FIG. 5.

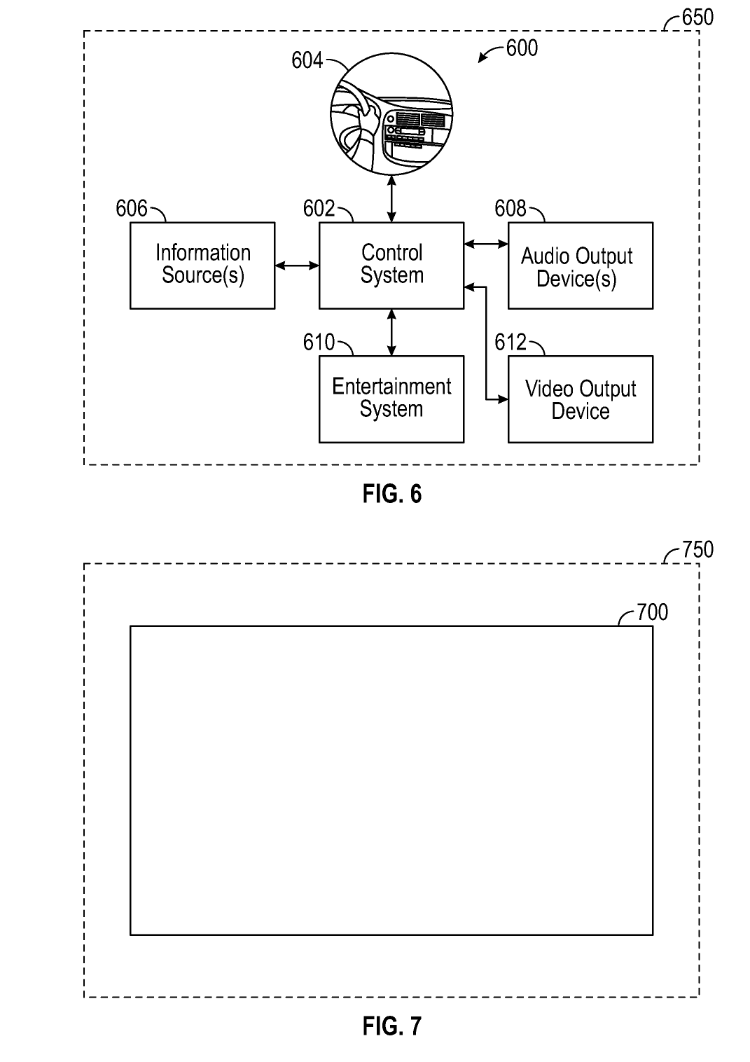

One exemplary implementation of any of the above-described exemplary touch screens 100, 200, 300, or 500 is illustrated in FIG. 6. Generally, vehicles, including, but not limited to, automobiles, trucks, buses, motorcycles, trains, marine vessels, aircraft, rotorcraft and the like, include information and entertainment (or “infotainment”) systems. In accordance with an exemplary embodiment, FIG. 6 schematically illustrates an exemplary infotainment system 600 that includes a video output or display 612 that may be embodied in accordance with any of the exemplary touch screens 100, 200, 300, or 500 described above. While the following discussion is based on implementation in a vehicle 650, the teachings herein may be applied in other contexts. For example, system 600 could be utilized with an automobile, truck, bus, motorcycle, train, marine vessel, aircraft, rotorcraft and the like, or in a home entertainment system. The infotainment system 600 (also referred to generally herein as “system”) may include an infotainment control system 602. The control system 602 receives inputs from various sources and controls access to the audio output device(s) 608. In one embodiment, audio output device(s) 608 may include one or more speakers. The control system 602 may receive input signals from an information system 606. The information system 606 may include, but is not limited to, a navigation system such as GPS chipset component, a personal digital assistant (PDA), a radio tuner, a cellular telephone, an Internet connection, a microphone, or any other device capable of providing information to the control system 602. The control system 602 may also receive input signals from an entertainment system 610. The entertainment system 610 may include, but is not limited to, one or more of a compact disk (CD) player, a radio tuner, a digital video disk (DVD) player, a portable media player, or other now available or later created devices that provide entertainment.

In order for the information or entertainment provided by the information source 606 or entertainment system 610 to be experienced by a passenger, the control system 602 provides the information or entertainment to one or both of the audio output 608 or video output or display 612. The audio output 608 may be a system of one or more speakers and the video output or display 612 may be, for example, one or more touch screens 100, 200, 300, or 500 located at one or more locations in the vehicle 650, in accordance with any of the embodiments described above. Typically, a user may control some or all of the infotainment system 600 through a user input device 604, which in some examples may include touch screen 100, 200, 300, 500. Based on inputs received from the user input device 604, the control system 602 may determine the device that has access to one or both of the audio output 608 and video output or display 612 and a volume level for at least the audio output 608.

Touch screens 100, 200, 300, or 500 in accordance with the present disclosure may also find other uses outside of vehicles, such as on portable electronic devices, in-home electronic devices (televisions, appliances, etc.), point-of-sale systems, robots, watches, public use displays (ATMs, kiosks) etc. Accordingly, the exemplary implementation shown in FIG. 6 should not be considered limiting. For example, FIG. 7 illustrates a touch screen 700 (embodied as any of the touch screen 100, 200, 300, 500) implemented on a non-vehicle device, system, or apparatus 750.

Accordingly, the present disclosure has provided various embodiments of touch screen systems that exhibit reduced touch latency variation as well as reduced diffraction. In some of the disclosed embodiments, reduced touch latency is achieved by varying the thickness of the conductive traces as a function of the length of such traces. In this manner, the RC time constant variation based on trace length is reduced. In other embodiments, reduced diffraction is achieved by providing irregular trace patterns that substantially exclude straight line segments and substantially exclude repeated patterns, as well as include varying distances between trace lines. In this manner, light passing through the traces does not reflect at any consistent frequency, thus reducing refraction. In still further embodiments, reduced diffraction is achieved by providing an insulative coating over the touch screen, wherein the coating has a refractive index that is substantially the same as the conductive trace material. In this manner, a low reflection efficiency is achieved, thus resulting in a low diffraction efficiency.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather than, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. A touch screen system comprising:
an electrically insulating, transparent substrate;
a plurality of transmit and receive electrodes comprising a conductive material patterned on the substrate and defining a plurality of capacitive touch zones on the substrate between respective ones of the transmit and receive electrodes; and
a plurality of trace lines, each trace line comprising the conductive material, each trace line patterned on the substrate extending from one of the transmit or receive electrodes to an edge terminal at an edge of the substrate,
wherein a first trace line of the plurality of trace lines has a length, defined from the respective touch zone to the respective edge terminal, that is greater than a length of a second trace line of the plurality of trace lines, and the first trace line has a width that is greater than a width of the second trace line.

2. The touch screen system of claim 1, wherein each trace line of the plurality of trace lines is defined as having an irregular trace pattern.

3. The touch screen system of claim 2, further comprising an insulative coating disposed over the substrate, the touch zones, the transmit electrodes, the receive electrodes and the plurality of trace lines,
wherein the insulative coating has a refractive index that is substantially identical to a refractive index of the conductive material.

4. The touch screen system of claim 1, further comprising an insulative coating disposed over the substrate, the touch zones, the transmit electrodes, the receive electrodes and the plurality of trace lines,
wherein the insulative coating has a refractive index that is substantially identical to a refractive index of the conductive material.

5. The touch screen system of claim 1, wherein a third trace line of the plurality of trace lines has a length that is less than the length of the second trace line, and the third trace line has a width that is less than the width of the second trace line.

6. The touch screen system of claim 1, wherein the conductive material comprises an indium tin oxide material.

7. The touch screen system of claim 1, wherein the touch screen system is associated with an infotainment system.

8. A touch screen system comprising:
an electrically insulating, transparent substrate;
a plurality of transmit and receive electrodes comprising a conductive material patterned on the substrate and defining a plurality of capacitive touch zones on the substrate between respective ones of the transmit and receive electrodes; and
a plurality of trace lines, each trace line comprising the conductive material, each trace line patterned on the substrate extending from one of the transmit or receive electrodes to an edge terminal at an edge of the substrate,
wherein each trace line of the plurality of trace lines is defined as having an irregular trace pattern.

9. The touch screen system of claim 8, further comprising an insulative coating disposed over the substrate, the touch zones, transmit electrodes, receive electrodes and the plurality of trace lines,
wherein the insulative coating has a refractive index that is substantially identical to a refractive index of the conductive material.

10. The touch screen system of claim 8, wherein the irregular trace pattern substantially excludes straight line segments.

11. The touch screen system of claim 8, wherein the irregular trace pattern substantially excludes repeating line patterns.

12. The touch screen system of claim 8, wherein a distance between a first trace line of the plurality of trace lines and a second trace line of the plurality of trace lines varies along lengths of the first and second trace lines.

13. The touch screen system of claim 8, wherein the conductive material comprises a conductive polymer material.

14. The touch screen system of claim 8, wherein the touch screen system is implemented in a non-vehicle device, system, or apparatus.

15. A touch screen system comprising:
an electrically insulating, transparent substrate;
a plurality of transmit and receive electrodes comprising a conductive material patterned on the substrate and defining a plurality of capacitive touch zones on the substrate between respective ones of the transmit and receive electrodes;
a plurality of trace lines, each trace line comprising the conductive material, each trace line patterned on the substrate extending from one of the transmit or receive electrodes to an edge terminal at an edge of the substrate; and
an insulative coating disposed over the substrate, the touch zones, the transmit electrodes, the receive electrodes and the plurality of trace lines,
wherein the insulative coating has a refractive index that is substantially identical to a refractive index of the conductive material.

16. The touch screen system of claim 15, wherein the refractive index of the insulative coating and the conductive material differ by less than about 20%.

17. The touch screen system of claim 16, wherein the refractive index of the insulative coating and the conductive material differ by less than about 10%.

18. The touch screen system of claim 15, wherein the conductive material comprises an indium tin oxide material and wherein the insulative coating comprises a silicon oxynitride material.

19. The touch screen system of claim 15, wherein the conductive material comprises an indium tin oxide material and wherein the insulative coating comprises a titanium oxynitride material.

20. The touch screen system of claim 15, wherein the trace lines extend in a generally L-shaped pattern from a respective touch zone to a respective edge of the substrate.
